(19) United States
(12) Patent Application Publication
(10) Pub. No.: US 2014/0093640 A1
(43) Pub. Date: Apr. 3, 2014

(54) WIRE AND CABLE EXTRUSION PROCESSES

(71) Applicant: APPLE INC., Cupertino, CA (US)

(72) Inventor: Joseph I. BRISKEY, Aptos, CA (US)

(73) Assignee: APPLE INC., Cupertino, CA (US)

(21) Appl. No.: 13/631,968

(22) Filed: Sep. 29, 2012

(51) Int. Cl. B29C 47/02

(52) U.S. Cl. 427/120; 118/69

(57) ABSTRACT

An extrusion system is described herein. The extrusion system includes a die and tip defining an extrusion cavity, the extrusion cavity configured to receive heated material for extrusion and coating one or more wires. Furthermore, an exit region of the die is configured to be cooled to a temperature less than that of the heated material during coating the one or more wires.

### FIELD OF THE DESCRIBED EMBODIMENTS

The described embodiments relate generally to wire and cable extrusion, and more particularly, to the manipulation of die exit temperature during wire and cable extrusion.

### BACKGROUND

Conventionally, wire and cable for personal electronic devices may be covered with an insulator jacket or jacketing. The insulator jacket may provide a plurality of features, including protection and wear reduction of underlying conductors. Depending upon a particular material and extrusion process used for the insulator jacket, cosmetic surfaces (e.g., surfaces visible by users) of wire and cable may include a variety of physical attributes which are undesirable.

For example, jacket material, including rubber and silicone compounds, may be used in an extrusion process to coat wire and cable as an insulator jacket. The cooled insulator jacket may display several undesirable physical attributes including weld lines, seams, surface roughness, glossy surfaces, and/or other undesirable attributes. Experimental adjustments to the extrusion process including temperature increases and wire velocity adjustments may allow reduction of some undesirable attributes under certain conditions. However, even controlled and automated changes to the extrusion process may lack repeatability of a desirable set of physical attributes, making it difficult to implement any experimental adjustments to real world manufacturing scenarios.

Therefore, what is needed is an adaptable extrusion process which overcomes these drawbacks and allows controlled repeatability of desirable physical attributes in a plurality of insulator jacket materials.

### SUMMARY OF THE DESCRIBED EMBODIMENTS

This paper describes various embodiments that relate to wire and cable extrusion processes.

According to one embodiment of the present invention, an extrusion system includes a die and tip defining an extrusion cavity, the extrusion cavity configured to receive heated material for extrusion and coating one or more wires. Furthermore, an exit region of the die is configured to be cooled to a temperature less than that of the heated material during coating the one or more wires.

According to another embodiment of the invention, an extrusion system includes a crosshead configured to receive and distribute heated material for extrusion, and a die and tip defining an extrusion cavity and an exit region in mechanical communication with the crosshead. The extrusion cavity is configured to receive the material for extrusion and coating one or more wires at the exit region. Furthermore, the exit region of the die is configured to be cooled to a temperature less than that of the heated material during coating the one or more wires.

According to another embodiment of the invention, a method of wire extrusion includes heating extrusion material, providing at least one wire to be coated by extrusion material, feeding heated extrusion material and the at least one wire to a crosshead, the crosshead comprising at least a die and a tip, manipulating a temperature of a portion of the die, the portion being proximate to an extrusion area and adjacent to an opening of the die, and cooling the coated wire.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

Various aspects of this disclosure may be better understood upon reading the following detailed description and upon reference to the drawings in which:

FIG. 1 is a wire extrusion system, according to an embodiment of the invention.

FIG. 2 is a flowchart of a method for cable extrusion, according to an embodiment of the invention.

FIG. 3 illustrates an exit temperature controlled die and tip of a wire extrusion system, according to an embodiment of the invention.

FIG. 4 is a frontal view of the exit temperature controlled die and tip of FIG. 3.

FIG. 5 illustrates an exit temperature controlled die and tip of a wire extrusion system, according to an embodiment of the invention.

FIG. 6 is a frontal view of the exit temperature controlled die and tip of FIG. 5.

### DETAILED DESCRIPTION OF SELECTED EMBODIMENTS

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

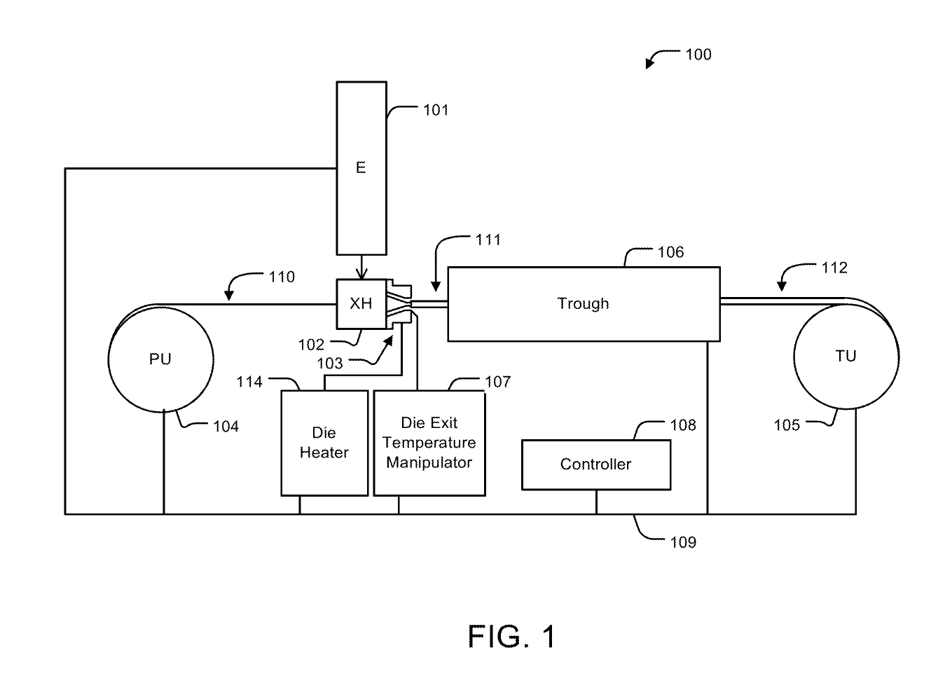

Turning to FIG. 1, a wire extrusion system 100 is illustrated, according to an embodiment of the invention. The system 100 may include material extruder 101. The material extruder 101 may include any suitable material extruder, and may include a plurality of separate components not individually illustrated for clarity. For example, the material extruder 101 may include a heating element to melt or soften jacket material, a hopper or feeder to supply raw or processed jacket material, and/or a material pump or screw to force softened or molten jacket material onto or through crosshead 102.

Crosshead 102 may be a member configured to receive molten or softened jack material from the material extruder 101 and force the same through die and tip set 103. The crosshead 102 may include an inlet to receive material and a manifold to distribute the received material into an extrusion cavity defined/formed by the die and tip set 103. The die and tip set 103 may be in mechanical communication with the crosshead 102 through the defined extrusion cavity.

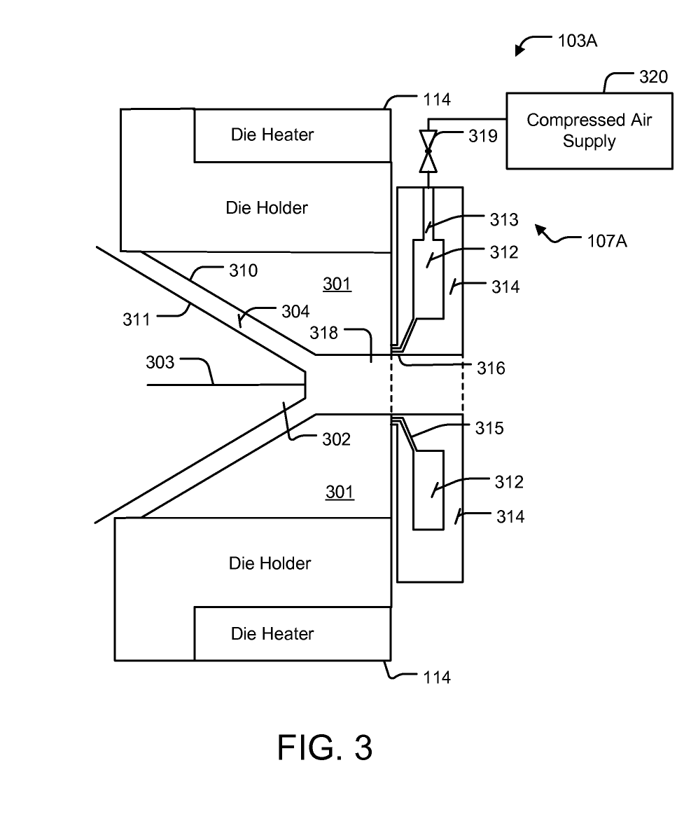

The die and tip set 103 may be components configured to receive and distribute jacket material over a wire, conductor, or plurality of the same, and may take a plurality of forms. For simplicity of discussion and brevity of text, exhaustive descriptions of every possible shape and form of a die and tip set are omitted herein. Example die and tip sets 103A and 103B are illustrated in FIGS. 3-6.

The system 100 may further include a Payoff 104 configured to hold and supply wire 110 to crosshead 102. Payoff 104 may be coupled to a motor or rotating mechanism configured to facilitate unwind and supply wire 110 from one or more reels configured to hold the wire 110. Wire 110 may include a single conductor, several insulated conductors, a set of insulated and non-insulated conductors, cabling, or any other suitable length of material to be coated with jacket material extruded through the system 100. According to one embodiment, the wire 110 is a communication cable for communicating electronic signals to/from a personal electronic device. According to another embodiment, wire 110 is a power cable for supplying power to a personal electronic device. According to another embodiment, wire 110 is a set of audio wires for transferring analog audio signals from a personal electronic device. According to another embodiment, wire 110 is a cable having at least one insulated conductor and shielding. It is noted that the examples listed above are not exhaustive, and discussion of every possible wire to be processed through system 100 is beyond the scope of this disclosure.

The system 100 further includes trough 106 configured to receive and cool coated wire 111 received from die and tip set 103. The trough 106 may be configured to actively or passively cool extruded material coating the coated wire 111. The trough may be integrally or fixedly attached proximate the die and tap set 103, or may be separated by a predetermined distance. According to one embodiment, the trough 106 is substantially formed of a conductive material configured to act as a heat sink. According to another embodiment, the trough 106 includes one or more heat sinks configured to receive heat from extruded material coating the wire 111. According to another embodiment, the trough 106 includes a cooling coil or tubing configured to actively transport heat received from extruded material coating the coated wire 111.

The system 100 further includes take up 112 configured to receive and store cooled cable 112. Cooled cable 112 may be a cooled form of coated cable 111, and may have cosmetic surface attributes of consistent and repeatable quality. The Takeup 105 may be coupled to a motor or rotating mechanism configured to turn Takeup 105 to facilitate receiving of the cooled cable 112. The Takeup 105 may include a reel or set of reels configured to wind and store the cooled cable 112.

The system 100 may further include die heater 114 coupled to one or both of the die and tip of set 103. The die heater 114 is configured to raise a nominal temperature of the die and tip set 103 such that flow characteristics of molten material allow for increased speed in an extrusion process. According to one embodiment of the invention, the die and tip set 103 may be heated to about 220 degrees Celsius. According to one embodiment of the invention, an interior extrusion cavity defined by the die and tip set 103 may be heated to about 220 degrees Celsius. According to one embodiment of the invention, the die and tip set 103 may be heated to a range of about 205-220 degrees Celsius. According to one embodiment of the invention, an interior extrusion cavity defined by the die and tip set 103 may be heated to a range of about 205-220 degrees Celsius.

The additional heat and speed afforded through use of the die heater 114 may introduce surface features on extruded material which under some circumstances may be undesirable. For example, additional heat and speed may promote increased surface glossiness of extruded material. However, according to embodiments of the invention, a die exit temperature may be manipulated to a temperature less than that of the heated extrusion material to reduce these characteristics.

For example, the system 100 may include die exit temperature manipulator 107 coupled proximate an exit of the die and tip set 103. The die exit temperature manipulator 107 may be configured to reduce a temperature of a limited area directly proximate the exit of the die and tip set 103 such that surface characteristics including glossiness are reduced. The die exit temperature manipulator 107 may take a variety of forms, including a heat sink, coiled tubing, air-flow nozzles, or other forms of temperature manipulation. These and other forms are described with reference to FIGS. 3-6.

Turning back to FIG. 1, the system may further include controller 108 configured to communicate to different components of the system 100 described above via one or more channels 109. Channels 109 may include standardized communication channels, discrete Input/Output (I/O) connections, isolated interlocks, and/or any other suitable communication mechanisms. The controller 108 may be any suitable controller, including a computer processor configured to execute a method of cable or wire extrusion as described herein. The controller 108 may be embodied as a general purpose processor or a specialized processor such as a programmable logic controller (PLC), programmable automation controller, computer numerical control (CNC) processor, or other specialized controller.

Although described above and illustrated as discrete components, it should be understood that one or more components of the system 100 may be integrated into a standalone extrusion apparatus for a product manufacturing facility. Furthermore, existing standalone extrusion apparatuses may be easily modified taking into consideration the teachings described herein to achieve significantly similar or substantially equivalent operation.

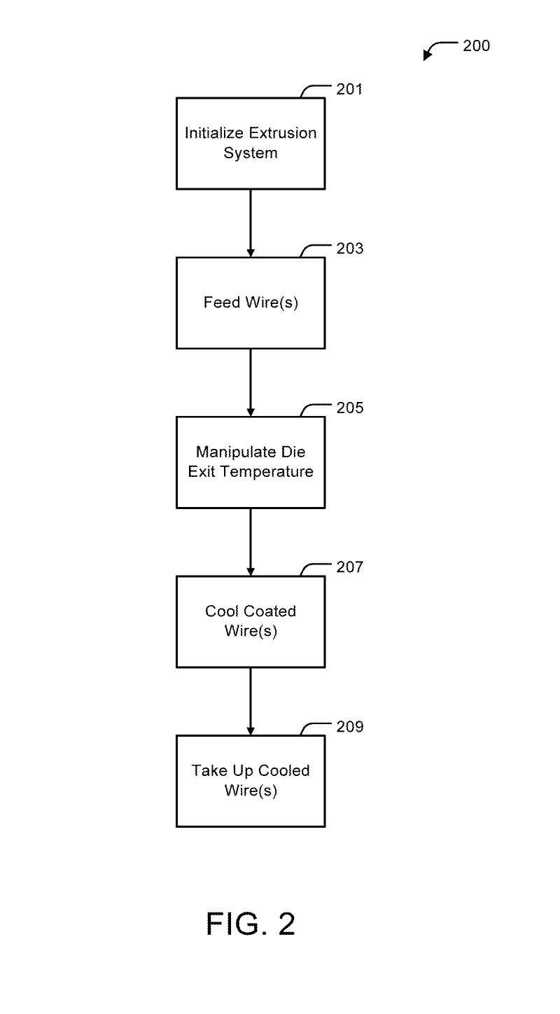

Hereinafter, a more detailed description of methods of extruding cabling and the physical characteristics of cabling resulting therefrom is provided with reference to FIG. 2.

FIG. 2 is a flowchart of a wire extrusion method 200, according to an embodiment of the invention. The method 200 includes initializing an extrusion system at block 201. Initializing the extrusion system may include initializing a material extruder 101 to begin to heat, soften, or melt material for extruding. The initializing may further include initializing a die heater to begin to heat a die and tip set. Furthermore, the initializing the extrusion system may include initializing one or more components of a wire extrusion system 100, for example, by preparing a controller 108 to execute extruding algorithms or control sequences, by preheating a material extruder 101 and beginning a flow of material therethrough, heating extrusion material to a first temperature for material extrusion, and/or other suitable or desirable initializing steps.

The method 200 further includes feeding wire or wires into a crosshead of the initialized extrusion system at block 203. Feeding the wire or wires may include passing wire to be coated through a receiving cavity of a crosshead 102 and into a central cavity of a tip of set 103 (see FIG. 1).

The method 200 further includes manipulating a die exit temperature at block 205. The manipulating may include reducing a temperature of an exit region of a die to a temperature less than an overall temperature of the die and/or less than the first temperature of the heated extrusion material. According to one embodiment of the invention, the manipulating may include controllably releasing compressed air over the exit region. According to one embodiment of the invention, the manipulating may include supplying coolant or a working fluid over/through a coolant supply tube proximate the exit region. The manipulating may further include controllably reducing the temperature of the exit region through use of a solid-state cooling device such as a heat pump or Peltier device.

The method 200 further includes cooling the coated wire at block 207. For example, cooling may be facilitated by a cooling trough 103, heat sink, or other cooling mechanism.

The method 200 further includes taking up cooled, coated wire at block 209. For example, a take up 105 may wind the cooled, coated wire onto one or more reels.

As described above, methods of extruding wire may include one or more steps including initializing an extrusion system, feeding wire into the extrusion system, manipulating a die exit temperature of the extrusion system while coating the wire to create coated wire, cooling the coated wire, and taking up the cooled coated wire. The temperature manipulation may be facilitated through controlled release of compressed air, supply of coolants or working fluids, and/or use of a solid-state cooling device. Hereinafter, variations of die exit temperature manipulation are explained with reference to FIGS. 3-6.

FIG. 3 illustrates an exit temperature controlled die and tip 103A of a wire extrusion system. As illustrated, the die 301 is a generally cylindrical die having an inner conical wall 310. The tip 302 is a generally conical tip having a central cavity 303 for passing one or more wires for coating, and an outer conical wall 311. When engaged together, the inner conical wall 310 and the outer conical wall 311 form an extrusion cavity 304. The extrusion cavity 304 may be generally frustoconical in shape having a distal cylindrical cavity 318 (e.g., die exit) for expelling extruded material onto wire. The extrusion cavity 304 may receive softened or molten material from a manifold of a crosshead and force the same about wire passing through central cavity 303.

As further illustrated, die exit temperature manipulator 107A is arranged proximate the die exit region 318. The manipulator 107A may include a member 314 arranged proximate the die exit region 318 configured to controllably release compressed air via nozzles or jets 316. The nozzles 316 may be supplied compressed air through supply features 315 and reservoir 312. Reservoir 312 may be in fluid communication with the supply features 315 and an inlet 313 configured to receive compressed air from a compressed air supply 320. The supply of compressed air may be controlled through one or more valves 319. The one or more valves 319 may be controlled through a controller such as controller 108, and/or may be directly controlled by an operator.

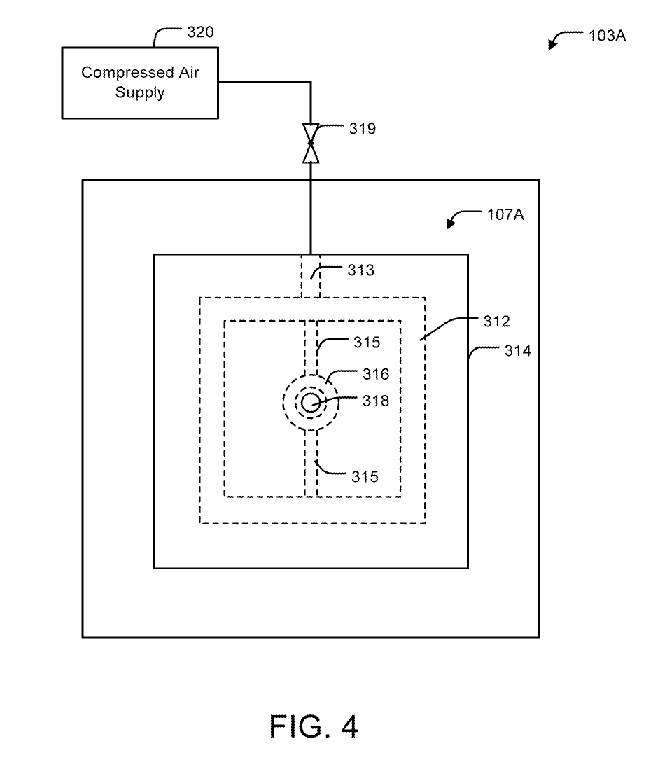

The die exit temperature manipulator 107A may be a substantially flat cylindrical construct arranged about a central axis collinear to the central cavity 303. This is more clearly illustrated in FIG. 4. As illustrated in FIG. 4, the region directly proximate the die exit region 318 may be susceptible to cooling through nozzles/jets 316. As such, the die exit temperature of the region 318 may be controllably reduced during extrusion of material using the die and tip set 103A.

Although illustrated above as relating to release of compressed air, it should be understood that a variety of cooling techniques may be applicable to any desired implementation of embodiments of the invention.

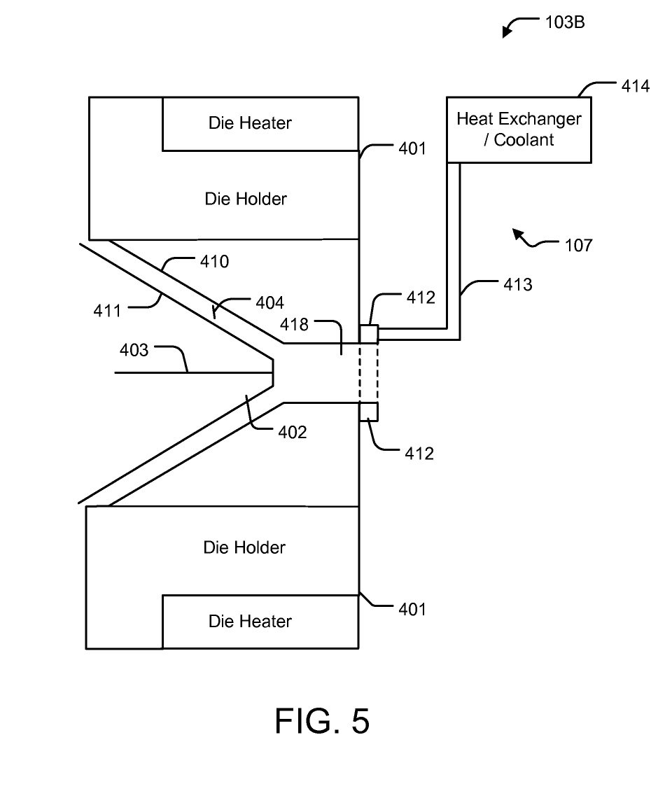

For example, FIG. 5 illustrates an exit temperature controlled die and tip 103B of a wire extrusion system. As illustrated, the die 401 is a generally cylindrical die having an inner conical wall 410. The tip 402 is a generally conical tip having a central cavity 403 for passing one or more wires for coating, and an outer conical wall 411. When engaged together, the inner conical wall 410 and the outer conical wall 411 form an extrusion cavity 404. The extrusion cavity 404 may be generally frustoconical in shape having a distal cylindrical cavity 418 (e.g., die exit) for expelling extruded material onto wire. The extrusion cavity 404 may receive softened or molten material from a manifold of a crosshead and force the same about wire passing through central cavity 403.

As further illustrated, die exit temperature manipulator 107B is arranged proximate the die exit region 418. The manipulator 107B may include a construct 412 arranged proximate the die exit region 418 configured to controllably transfer heat away from the die exit region 418. The construct 412 may be a generally solid construct transferring heat to a heat exchanger 414 through supply features 413. In this scenario, heat is transferred to due temperature disparity between the die exit region 418 and the heat exchanger 414.

Alternatively, coolant or a working fluid (e.g., fluid, water, alcohol, gas, etc) may be circulated through the construct 412 in an active manner. In this scenario, heat exchanger 414 may supply coolant through the supply features 413 and receive the same from construct 412.

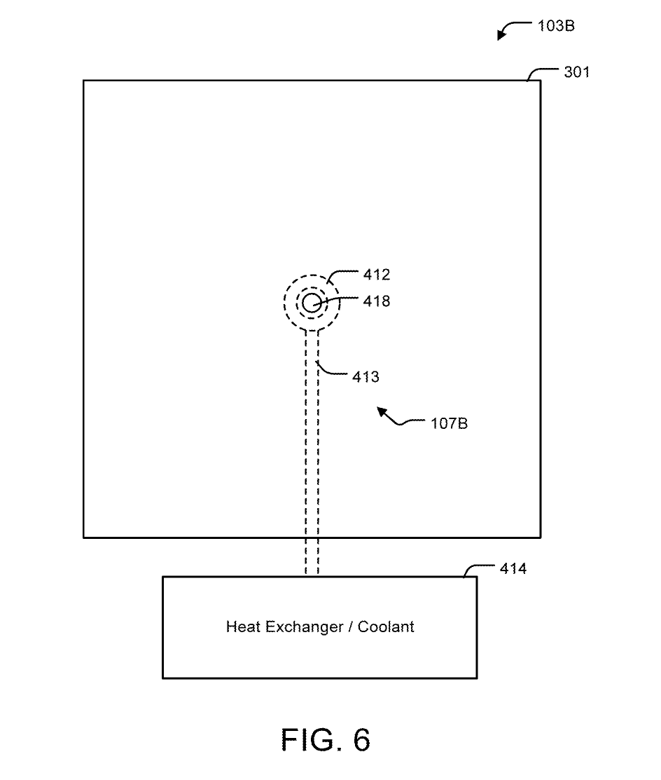

The die exit temperature manipulator construct 412 may be a substantially flat cylindrical construct arranged about a central axis collinear to the central cavity 403. If used to passively transfer heat, the construct 412 may be formed of a solid piece of a conductive material such as, for example, copper or aluminum. Construct 412 may also be formed of tubing configured to actively circulate a working fluid/coolant, or passively transfer heat through use of coolant. The cylindrical form of construct 412 is more clearly illustrated in FIG. 6. As illustrated in FIG. 6, the region directly proximate the die exit region 418 may be susceptible to cooling through construct 412. As such, the die exit temperature of the region 418 may be controllably reduced during extrusion of material using the die and tip set 103B.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line or extrusion system somewhat similar to those described herein. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. An extrusion system, comprising:
a die and tip defining an extrusion cavity, the extrusion cavity configured to receive heated material for extrusion and coating one or more wires, wherein an exit region of the die is configured to be cooled to a temperature less than that of the heated material during coating the one or more wires.

2. The system of claim 1, further comprising:
a temperature manipulator configured to cool the exit region of the die.

3. The system of claim 2, wherein the temperature manipulator comprises at least one nozzle configured to controllably release air proximate the exit region.

4. The system of claim 2, wherein the temperature manipulator comprises at least one of a solid-state cooling device and a heat exchanger arranged proximate the exit region.

5. The system of claim 1, further comprising:
a material extruder, the material extruder configured to heat material for extruding and transfer the heated material to the crosshead manifold.

6. The system of claim 5, further comprising:
a trough, the trough configured to receive and cool coated wire.

7. The system of claim 6, further comprising:
a take up, the take up configured to receive and store cooled coated wire.

8. The system of claim 7, wherein:
the tip comprises a central cavity configured to receive one or more wires to be coated.

9. The system of claim 8, further comprising:
a wire Payoff, the wire Payoff configured to supply wire to the central cavity of the tip.

10. The system of claim 6, wherein the crosshead, material extruder, and trough are integrally arranged as a standalone extrusion apparatus.

11. An extrusion system, comprising:
a crosshead configured to receive and distribute heated material for extrusion; and
a die and tip defining an extrusion cavity and an exit region in mechanical communication with the crosshead, the extrusion cavity configured to receive the material for extrusion and coating one or more wires at the exit region;
wherein the exit region of the die is configured to be cooled to a temperature less than that of the heated material during coating the one or more wires.

12. The system of claim 11, further comprising:
a temperature manipulator configured to cool the exit region of the die.

13. The system of claim 12, wherein the temperature manipulator comprises at least one of a solid-state cooling device, a compressed air nozzle, and a heat exchanger.

14. The system of claim 11, further comprising:
a material extruder, the material extruder configured to heat material for extruding and transfer the heated material to the crosshead; and
a trough, the trough configured to receive and cool coated wire.

15. The system of claim 14, further comprising:
a take up, the take up configured to receive and store cooled coated wire.

16. The system of claim 15, wherein:
the tip comprises a central cavity configured to receive one or more wires to be coated.

17. The system of claim 16, further comprising:
a wire Payoff, the wire Payoff configured to supply wire to the central cavity of the tip.

18. The system of claim 14, wherein the crosshead, material extruder, and trough are integrally arranged as a standalone extrusion apparatus.

19. A method of wire extrusion, comprising:
heating extrusion material;
providing at least one wire to be coated by extrusion material;
feeding heated extrusion material and the at least one wire to a crosshead, the crosshead comprising at least a die and a tip;
manipulating a temperature of a portion of the die, the portion being proximate to an extrusion area and adjacent to an opening of the die; and
cooling the coated wire.

20. The method of claim 19, wherein manipulating the temperature comprises:
controllably releasing air adjacent the opening of the die.

21. The method of claim 19, wherein manipulating the temperature comprises:
controllably reducing the temperature of the portion of the die with a solid-state cooling device coupled to the die.

22. The method of claim 19, wherein manipulating the temperature comprises:
circulating a working fluid or coolant through a construct adjacent the opening of the die.
